(19) United States
(12) Patent Application Publication
(10) Pub. No.: US 2013/0157484 A1
(43) Pub. Date: Jun. 20, 2013

(54) WING-SHAPED AND COMBINED RETRACTABLE PLUG

(71) Applicant: Chi Sang CHIU, Kowloon (HK)

(72) Inventor: Chi Sang CHIU, Kowloon (HK)

(73) Assignee: KASS INTERNATIONAL INDUSTRIAL LIMITED, Kowloon (HK)

(21) Appl. No.: 13/346,751

(22) Filed: Jan. 10, 2012

(30) Foreign Application Priority Data
Dec. 20, 2011 (CN) 201120535947.4

(51) Int. Cl. H01R 13/44

(52) U.S. Cl. 439/136

(57) ABSTRACT

The invention discloses a wing-shaped and combined retractable plug, a front end as a fixed connector and two opposite lateral sides as a first retractable connector and a second retractable connector. The incorporation of the fixed connector, and the first and second connectors through the upper and lower shells results in a combined plug, which may charge up to three devices simultaneously or be used for data transmission with one device. The combined plug may contain different types of interfaces, so that the types and number of the connectors required to be carried are reduced. Since connecting wires are connected directly to the fixed connector and the first and second connectors, the transmission circuit resistance is reduced and more devices may be simultaneously charged and connected for data transmission. Compared with plugs in the prior art, the present combined plug is small sized and easy to operated.

### FIELD OF THE INVENTION

The present application relates to a plug, and particularly to a wing-shaped and combined retractable plug.

### BACKGROUND OF THE INVENTION

The existing customer appliances mainly include those in the field of communications, including devices in Apple® series, various cell phones, various peripheral devices related to computers and so on. Power plugs and data interfaces of such devices tend to be uniform, and generally include a Universal Serial Bus (USB) connector and an Apple 30-pin connector. To simultaneously carry devices with two or more of the above power plugs and data interfaces during a travel or any outgoing, users are required to bring with themselves various corresponding data interfaces for charging and data transmission to ensure normal operating of the devices. As a result, the data interfaces to be carried by the users are increased and cause inconvenience for the users. In addition, it is not easy for operating the devices provided with different data interfaces.

### SUMMARY OF THE INVENTION

An object of the present invention is to address the above technical problems. The present application provides a wing-shaped and combined retractable plug which is advantageous for a small size, easy operation and great portability.

The object of the present invention is solved by the following technical solutions.

There is provided a wing-shaped and combined retractable plug, a front end of which is provided with a fixed connector and two opposite lateral sides of which are provided with a first retractable connector and a second retractable connector, respectively.

Further, the wing-shaped and combined retractable plug includes an upper shell and a lower shell, which are engaged with each other in one piece.

Preferably, the fixed connector is an Apple 30-pin connector or a USB AIM connector.

Further, the first and second connectors are disposed symmetrically at two opposite lateral sides of the upper and lower shells between the upper and lower shells.

Further, two bores for guide pole are provided on an engaging face of each of the upper and lower shells, and such two bores of the upper shell face those two bores of the lower shell. Guide poles corresponding to the bores are disposed on each of the first and second connectors, thereby enabling the first and second connectors to be rotatablely disposed between the upper and lower shells.

Further, each of the upper and lower shells is provided with grooves for accommodating the first and second connectors, to enable the first and second connectors to be retractably amounted on those two lateral sides of the upper and lower shells.

Further, the grooves are positioned at lateral sides of the upper and lower shells, and the grooves of the upper and lower shells match with, each other to form cavities for receiving the first and second connectors.

Preferably, the first connector is a Micro-USB connector or a Mini-USB connector.

Preferably, the second connector is a Micro-USB connector or a Mini-USB connector.

The present invention is advantageous as follows. The incorporation of the fixed connector, the first connector and the second connector through the upper and lower shells results in a combined plug, which is capable of charging up to three devices simultaneously or used for data transmission with one device. The combined plug may also contain different types of interfaces, so that the types and number of the connectors required to be carried may be reduced for the purpose of outgoing or traveling. Since connecting wires are connected directly to the fixed connector and the first and second connectors, the resistance of the transmission circuit is significantly reduced, and more devices may be simultaneously charged and provided with data transmission. Compared with plugs in the prior art, the combined plug of the present invention is superior for a small size, easy operation and great portability.

### BRIEF DESCRIPTION OF THE DRAWINGS

The present invention is further described below in connection with embodiments and the drawings, in which,

FIG. 1 is a schematic exploded view of a wing-shaped and combined. retractable plug of the present invention;

FIG. 2 is a schematic diagram of the combined retractable plug of FIG. 1 in a state in which a first connector and a second connector are retraced into the shell;

FIG. 3 is a schematic diagram of the combined retractable plug of FIG. 1 in a state in which the second connector is retraced into the shell;

FIG. 4 is a schematic diagram of the combined retractable plug of FIG. 1 in a state in which the first connector is retraced into the shell; and

FIG. 5 is a schematic diagram of the combined retractable plug of FIG. 1 in a state in which the first and second connectors are drawn out from the shell.

### REFERENCE LIST

1: upper shell; 2: lower shell; 3: Fixed connector;

4: First connector; 5: Second connector.

### DETAILED DESCRIPTION OF THE EMBODIMENTS

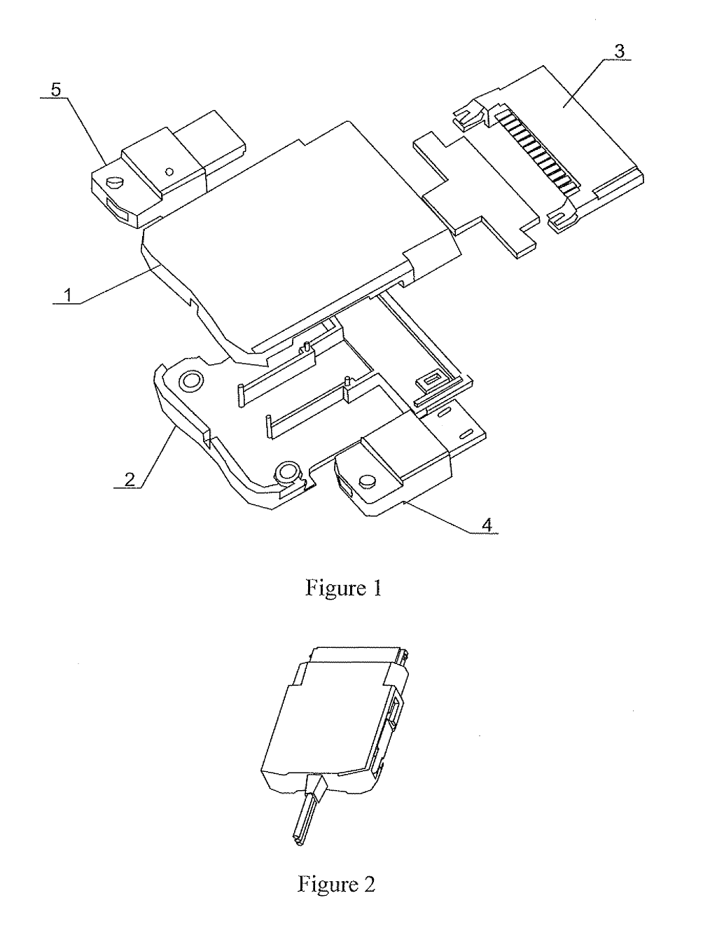

In an embodiment as shown in FIG. 1, there is provided a wing-shaped and combined retractable plug, a front end of which is provided with a fixed connector 3 and two opposite lateral sides of which are provided with a first retractable connector 4 and a second retractable connector 5, respectively. The wing-shaped and combined retractable plug may further include an upper shell 1 and a lower shell 2, which are engaged with each other in one piece. The first and second connectors 4 and 5 may be disposed symmetrically at two opposite lateral sides of the upper and lower shells between the upper and lower shells. Further, two bores for guide pole are provided on an engaging face of each of the upper and lower shells 1 and 2, with said two bores of the upper shell 1 facing said two bores of the lower shell 2, and guide poles corresponding to the bores are disposed on each of the first and second connectors 4 and 5, thereby enabling the first and second connectors 4 and 5 to be rotatablely retracted freely. Further, each of the upper and lower shells is provided with grooves for accommodating the first and second connectors 4 and 5, and the grooves of the upper and lower shells 1 and 2 match with each other to form cavities for receiving the first and second connectors 4 and 5, to enable both the first and second connectors 4 and 5 to be retractably amounted on those two lateral sides of the upper and lower shells.

The connectors may be configured as in the following first to sixth embodiments, for example.

In a first embodiment, the fixed connector 3 is configured as an Apple 30-pin connector, and the first and second connectors 4 and 5 are configured as Mini-USB connectors.

In a second embodiment, the fixed connector 3 is configured as an Apple 30-pin connector, and the first and second connectors 4 and 5 are configured as Micro-USE connectors.

In a third embodiment, the fixed connector 3 is configured as an Apple 30-pin connector, the first connector 4 is configured as a Mini-USB connector, and the second connector 5 is configured as a Micro-USB connector.

In a fourth embodiment, the fixed connector 3 is configured as a USE AIM connector, and the first and second connectors 4 and 5 are configured as Mini-USB connectors.

In a fifth embodiment, the fixed connector 3 is configured as a USB A/M connector, and the first and second connectors 4 and 5 are configured as Micro-USB connectors.

In a sixth embodiment, the fixed connector 3 is configured as a USB A/M connector, the first connector 4 is configured as a Mini-USB connector, and the second connector 5 is configured as a Micro-USE connector.

The wing-shaped and combined retractable plug may be used in the following cases.

As shown in FIG. 2, the first connector 4 and the second connector 5 may be retracted into the shells when merely the fixed connector 3 is used for charging and data transmission.

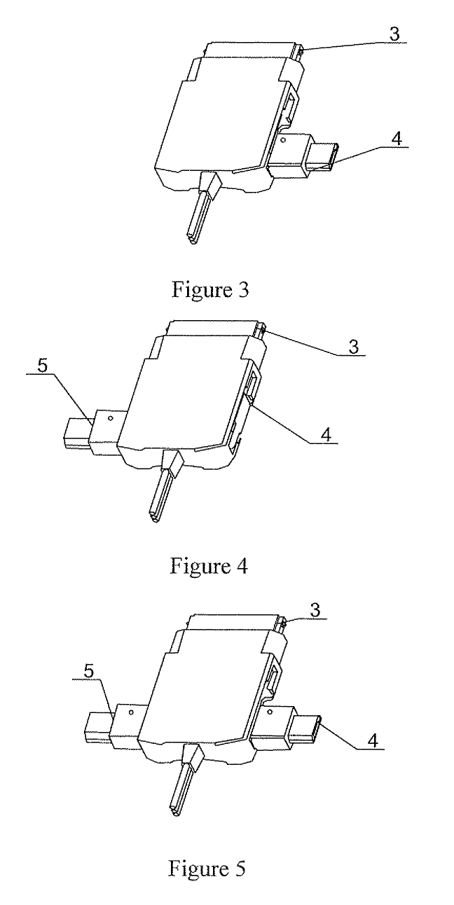

As shown in FIG. 3, when the fixed connector 3 and the first connector 4 are used for charging, or one of them is used for charging and the other is used for data transmission with one device, the first connector 4 is drawn out and the second connector 5 is retracted into the shells.

As shown in FIG. 4, when the fixed connector 3 and the second connector 5 are used for charging, or one of them is used for charging and the other is used for data transmission with one device, the second connector 5 is drawn out and the first connector 4 is retracted into the shells.

As shown in FIG. 5, when the fixed connector 3 and the first and second connectors 4 and 5 are used for charging, or one of them is used for data transmission with one device, the first and second connectors 4 and 5 may be drawn out.

The incorporation of the fixed connector 3, the first connector 4 and the second connector 5 through the upper and lower shells 1 and 2 results in a combined plug, which is capable of charging up to three devices simultaneously or used for data transmission with one device. The combined plug may also contain different types of interfaces, so that the types and number of the connectors required to be carried may be reduced for the purpose of outgoing or traveling. Since connecting wires are connected directly to the fixed connector 3 and the first and second connectors 4 and 5, the resistance of the transmission circuit is significantly reduced, and more devices may be simultaneously charged and provided with data transmission. Compared with plugs in the prior art, the combined plug of the present invention is superior for a small size, easy operation and great portability.

1. A wing-shaped and combined retractable plug, characterized in that a fixed connector is provided at a front end of the plug, and a first retractable connector and a second retractable connector are respectively provided at two opposite lateral sides of the plug.

2. The retractable plug of claim 1, further comprising an upper shell and a lower shell, which are engaged with each other in one piece.

3. The retractable plug of claim 1, wherein the fixed connector is an Apple 30-pin connector or a USB A/M connector.

4. The retractable plug of claim 2, wherein the first and second connectors are disposed symmetrically at the opposite lateral sides of the upper and lower shells between the upper and lower shells.

5. The retractable plug of claim 4, wherein two bores for guide pole are provided on an engaging face of each of the upper and lower shells, with said two bores of the upper shell facing said two bores of the lower shell, and guide poles corresponding to the bores are disposed on each of the first and second connectors, thereby enabling the first and second connectors to be rotatablely disposed between the upper and lower shells.

6. The retractable plug of claim 5, wherein each of the upper and lower shells is provided with grooves for accommodating the first and second connectors, to enable the first and second connectors to be retractably amounted on said two lateral sides of the upper and lower shells.

7. The retractable plug of claim 6, wherein the grooves are positioned at lateral sides of the upper and lower shells, and the grooves of the upper and lower shells match with each other to form cavities for receiving the first and second connectors.

8. The retractable plug of claim 1, wherein the first connector is a Micro-USB connector or a Mini-USB connector.

9. The retractable plug of claim 1, wherein the second connector is a Micro-USB connector or a Mini-USB connector.
